(19) United States
(12) Patent Application Publication
(10) Pub. No.: US 2011/0139823 A1
(43) Pub. Date: Jun. 16, 2011

(54) Solution Dispensing Wristband

(76) Inventor: Robert Staudt, LaVernia, TX (US)

(21) Appl. No.: 12/639,120

(22) Filed: Dec. 16, 2009

(51) Int. Cl. B67D 7/84

(52) U.S. Cl. 222/175

(57) ABSTRACT

A wristband for dispensing a solution in gelatinous, foam, or liquid form. The wristband has at least one hollow tube defining an interior space, which wristband is positionable about the wrist of a user. The desired solution is contained in the interior space. At least a portion of the hollow tube is compressible. A dispensing hole is disposed through a sidewall providing access to the interior space of the wristband where the solution is contained.

### CROSS-REFERENCES TO RELATED APPLICATIONS

Not applicable.

### STATEMENT REGARDING FEDERALLY-SPONSORED RESEARCH OR DEVELOPMENT

Not applicable.

### BACKGROUND OF THE INVENTION

1. Field of the Invention

The present invention relates to a portable wristband for dispensing a solution. More specifically, the present invention relates to a wristband that contains a solution in gelatinous, foam, or liquid form, such as a sanitizing or moisturizing solution, to be selectively dispensed by the wearer.

2. Description of the Related Art

An alcohol rub, also called a hand sanitizer, healthcare personnel hand wash, or a hand antiseptic, is often used as a supplement or alternative to hand washing with soap and water. For example, when hands are not visibly dirty, the Center for Disease Control and Prevention considers alcohol sanitizers an acceptable alternative to soap and water for hand hygiene. A variety of preparations are available, including gels, foam, and liquid solutions.

Currently, portability of hand sanitizing rubs is limited to simply reducing the size of the vessel containing the solution. While reducing the size of the container without altering its shape is beneficial for portability, the containers must still be carried in a pocket or purse. When a user wishes to use the hand sanitizer, he or she must still locate and retrieve the container, which is inconvenient and time consuming.

### SUMMARY OF THE INVENTION

The present invention is a hollow, tubular wristband for dispensing a solution in gelatinous, foam, or liquid form. The wristband has an exterior surface and an interior surface defining an interior space for containing a solution, which wristband is positionable about a user's wrist. The solution is contained within the wristband, may be hand sanitizer, moisturizer, and the like in gelatinous, foam, or liquid form. At least a portion of the wristband is compressible. A dispensing hole disposed through a sidewall of the wristband provides an outlet for the solution contained in the interior space of the tube. By compressing a portion of the wristband, solution is forced out the dispensing hole. The wristband can be a fully enclosed tubular body or it can be formed of a hollow tube having first and second ends coupled together with a coupling member.

### BRIEF DESCRIPTION OF THE DRAWINGS

FIG. 1 is a partial sectional front elevation of a preferred embodiment of present invention.

FIG. 2 is a sectional elevation through Line 2-2 of FIG. 1.

FIG. 3 is an elevation of the preferred embodiment through Line 3-3 of FIG. 1.

FIG. 4 is a front elevation of the preferred embodiment wherein the first tubing section is compressed.

FIG. 5 is a partial sectional elevation of an alternative embodiment of the present invention.

FIG. 6 is a perspective view of the coupling member of the alternative embodiment.

### DESCRIPTION OF THE INVENTION

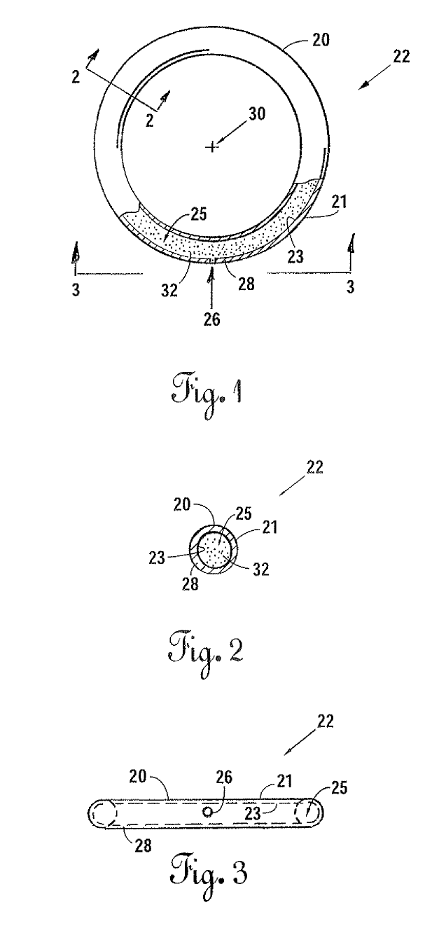

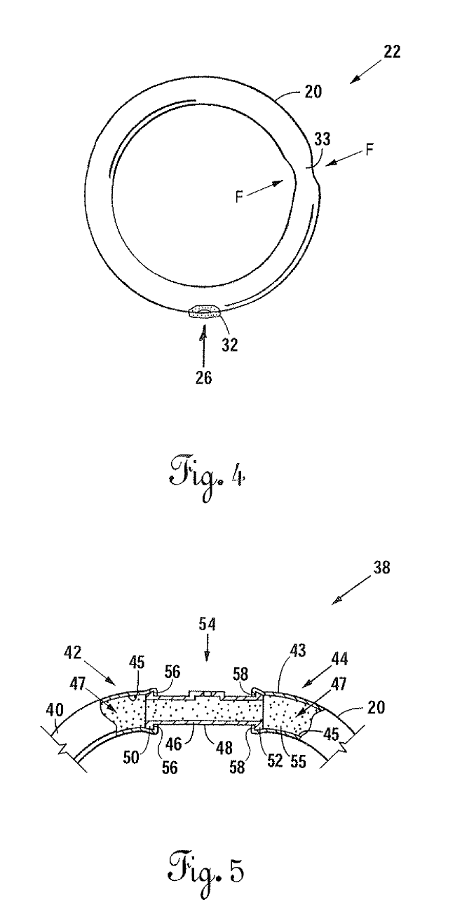

FIG. 1 through FIG. 3 depict the preferred embodiment of present invention. The hollow wristband 22 formed of an enclosed tube 20 in the general shape of a ring is positionable on the wrist of a person in the same manner as a bracelet. The tube 20 has a flexible wall 28 with an exterior surface 21 and an interior surface 23 which defines an interior space 25. A dispensing hole 26 having a preferred diameter of 0.1 inch is disposed through the wall 28 of the wristband 22. Additionally, it is preferred that at the location of the dispensing hole 20 it is orientated traverse to the orientation of the exterior surface. However, it is anticipated that the size of the hole 26 could vary slightly and still satisfy the objects of this invention. Preferably, the wristband 22 is constructed of cylindrical vinyl tubing having an outer diameter between 0.250 and 0.500 inches and an inner diameter between 0.125 and 0.375 inches. However, it is anticipated that these dimensions could vary and alternative embodiments also contemplate non-cylindrical shapes for the wristband 22.

The wristband 22 acts as a vessel to contain a solution 32, which solution may be a gelatinous, foam, or liquid of a viscosity such that the contained solution will not egress from the dispensing hole 26 without an external force being applied to a least a portion of the wristband 22. The wristband 22 is preferably transparent to allow the user to visually assess the amount of the solution 32 contained at any particular time, but opaque or solid tubing may also be used.

To use the wristband 22, the desired solution 32 is first delivered into the wristband 22. In the preferred embodiment, this can be done by injecting the solution 32 directly into the dispensing hole 26 to substantially fill the interior space 22. Alternatively, if the first tubing section 20 has joined ends, the ends can first be unjoined, and the solution 32 thereafter distributed through one of the ends until the interior space of the wristband 22 is substantially filled. The ends may thereafter be rejoined.

As shown in FIG. 4, by compressing a portion 33 of the wall 28 of tube 20 with a force F (e.g., by pinching the tube 20), the volume of the interior space is decreased, causing the solution 32 to displace away from the compressed portion 33 and, if a sufficient volume of solution 32 is contained, the solution 32 will be forced from the dispensing hole 26 and be available for sanitizing, moisturizing, and the like. The solution 32 can be dispensed from the wristband 22 with one hand while the wristband 22 remains positioned around the opposite wrist. As solution 32 is depleted with continued use by the wearer, compression at a single portion of the tube 20 may become insufficient to displace the solution 32 through the interior space to force the solution 32 from the dispensing hole 26. However, the portion 33 of the tube 20 can be compressed and the compressed portion 33 then “worked” toward the dispensing hole 26 by relocating the point of compression gradually toward the dispensing hole 26 to cause the remaining contained solution 32 to displace through the interior space toward, and eventually out of, the dispensing hole 26.

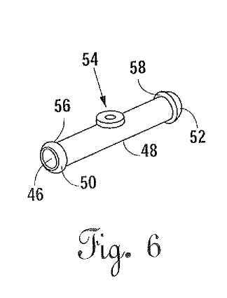

FIG. 5 is a partial sectional front elevation of a second embodiment of the present invention wherein the hollow wristband 38 is formed by a hollow tube 40 joined to a coupling member 48 (see FIGS. 5 and 6). Preferably, in this embodiment, the hollow tube 40 is a cylindrical, vinyl tube having first and second ends 42, 44. The hollow tube 40 has a wall 41, an exterior surface 43 and interior surface 45 forming an interior space 47. The diameters of the interior surface 41 and exterior surface have the same general dimensions as described in the preferred embodiment. In this embodiment, the coupling member 48 is preferably hollow and made of a rigid nylon material with first and second flanged ends 50, 52 creating first and second shoulders 56, 58. Further, a dispensing hole 54 is disposed through a sidewall 46 of the second hollow coupling member 48 to provide access to and from its interior space. In another version of the embodiment, the dispensing hold is through the wall of the tube 40 and the coupling member 48 can have a solid or hollow body.

In the second embodiment, the joining of the first and second tubing sections 40, 48 is accomplished by sliding the first and second ends 42, 44 of the hollow tube 40 over the first and second flanged ends 50, 52, respectively of the coupling member 48. The first and second shoulders 56, 58 are both sized to have a slightly larger diameter than the diameter of the interior surface 41 of the hollow tube 40 in an unstretched condition. The first and second shoulder 56, 58 of the coupling member 48 make frictional contact with the inner surface of the hollow tube 40, thereby causing the tube 40 to remain secured to the hollow coupling member 48.

Use of this embodiment is substantially as described with reference to FIG. 1 through FIG. 4 supra. First, the desired solution 55 is distributed into the interior space 47 of wristband 38 by injecting the solution 55 directly into the dispensing hole 54 until the interior space 47 is substantially filled. Alternatively, either the first end 42 or second end 44 of the tube 40 may be removed from the coupling member 48 and solution 55 thereafter distributed into the tube 40 through one of its ends 42, 44. After re-joining the removed end to the coupling member 48, the wristband can be placed and worn on the wrist of the user. By compressing a portion of the tube 40 as described with reference to FIG. 4, the volume of the interior space is decreased at the compression point, causing the solution 55 to displace away from the compression point and, if a sufficient volume of solution 55 is contained, be forced from the dispensing hole 54. As solution 55 is depleted with continued use, compression alone may become insufficient to cause egress of the solution 55 from the dispensing hole 54. The compressed portion must be “worked” toward the dispensing hole 54 to cause the contained solution 55 to displace through the tube 40 and eventually out of the dispensing hole 54.

The present invention is described in terms of preferred embodiments in which a specific system and method are described. Those skilled in the art will recognize that alternative embodiments of such system, and alternative applications of the method, can be used in carrying out the present invention. Other aspects and advantages of the present invention may be obtained from a study of this disclosure and the drawings, along with the appended claims. Moreover, the recited order of the steps of the method described herein is not meant to limit the order in which those steps may be performed.

I claim:

1. An wristband for dispensing a solution, the wristband comprising:
a hollow tube having a wall with an exterior surface and interior surface;
said wall enclosing an interior space;
a dispensing hole disposed through said wall of said hollow tube providing access to said interior space; and
said wall being made of a flexible material.

2. The wristband of claim 1 further comprising a volume of solution contained in said interior space.

3. The wristband of claim 1 wherein at least a portion of said wall is transparent.

4. The wristband of claim 1 wherein said hollow tube is a fully enclosed loop.

5. The wristband of claim 1 wherein said wristband further comprises:
a first and second ends of said hollow tube;
a coupling member having first and second ends;
said first end of said coupling member being joined to said first end of said hollow tube and said second end of said coupling member being joined to said second end of said hollow tube.

6. The wristband of claim 4 wherein said coupling member is rigid.

7. The wristband of claim 4 wherein said first and second ends of said coupling member are flanged.

8. The wristband of claim 4 wherein said coupling member is a hose barb.

9. The wristband of claim 4 wherein said dispensing hole is disposed through a sidewall of said coupling member.

10. The wristband of claim 1 wherein the solution is one of a gelatinous solution, a foam solution, and a liquid solution.

11. The wristband of claim 1 wherein said solution is a sanitizer.

12. The wristband of claim 1 wherein said solution is an antiseptic sanitizer.

13. The wristband of claim 1 wherein said solution is an anti-bacterial sanitizer.

14. The wristband of claim 1 wherein said solution is a moisturizer.
